(19) United States
(12) Patent Application Publication
(10) Pub. No.: US 2002/0134972 A1
(43) Pub. Date: Sep. 26, 2002

(54) Car jack

(76) Inventor: Ferdinand Alten, Mandern (DE)

Correspondence Address: Max Fogiel, 61 Ethel Road West, Piscataway, NJ, 08854, US

(21) Appl. No.: 10/088,547

(22) PCT Filed: Jun. 20, 2001
(86) PCT No.: PCT/EP01/06934

(30) Foreign Application Priority Data
Jul. 19, 2000 (DE) 100 35 165.4

(51) Int. Cl. B66F 3/00

(52) U.S. Cl. 254/126

(57) ABSTRACT

Jack with an erect component in the form of a leg (1) that rests against the ground (4) and of a foot (2) articulated thereto and with a vehicle-lifting arm (6) that pivots around a fixed horizontal axis on the leg. The arm can be directly or indirectly raised or lowered away from and toward the ground by means of a spindle (7). The arm is provided with a fixed or pivoting vehicle-supporting component at its free end. At the other end, which engages the leg, the arm is provided with appropriate controls that displace a slide (10) along the leg such that the lower end (19) of the slide can come to rest against the leg-supporting surface (3) of the foot. The object is a lighter-weight jack that will be just as sturdy. A stop (21) is accordingly positioned on top of the leg-supporting surface and facing the slide's lower end.

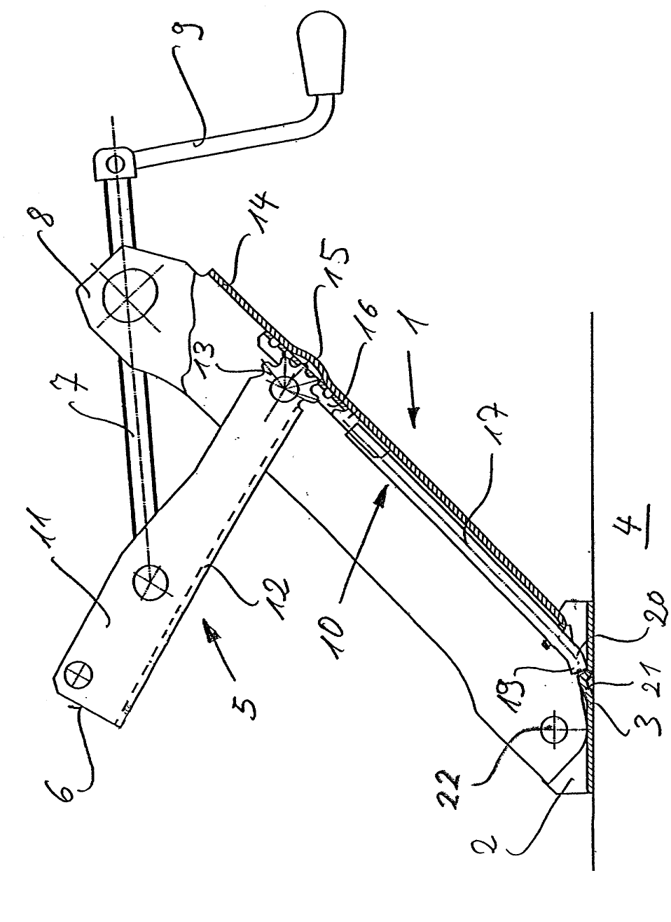

The present invention concerns a jack with an erect component that rests against the ground and with a vehicle-supporting arm that pivots around a horizontal axis on the erect component as recited in claim 1.

In a jack with a leg that rests against the ground by way of a foot and with an arm that pivots up at one end around an axis on the leg and raises the vehicle relative to the leg, care must in particular be taken to ensure that the leg can be applied, erected on the ground, that is, at a specific angle to the vehicle and to the ground. This approach is the only way to ensure that the load will be correctly accommodated as the vehicle is raised and to prevent the jack and hence the vehicle from slipping out of alignment because the line of force does not extend perpendicular through the foot. To facilitate application of the jack with the leg at the proper angle to the ground even when employed by unskilled individuals accordingly, European Patent 0 688 736 A1 discloses a slide that travels back and forth along the leg subject to the motion of the arm and establishes the jack's angle of application by controlling the motion of the foot articulated to the leg.

One end of the foot-motion controlling slide rests against the top of the foot's leg-supporting surface. At this end, the slide is bent out either forward or backward depending on the jack's kinematics and on the point where the jack comes into contact with the vehicle.

There is a drawback to this embodiment, especially when the slide does not rest perpendicular against the foot, resulting in powerful lateral force components. In this event, the slide must be especially bending-resistant and its lower guide correspondingly thick. The embodiment accordingly requires a lot of material.

The object of the present invention is a lighter-weight jack, and one that will be less heavy to transport in the vehicle.

This object is attain in accordance with the present invention by the characteristics recited in claim 1. Advantageous and advanced versions are addressed in claims 2 and 3.

The stop on the foot's leg-supporting surface and facing the end of the slide precisely establishes the end's position. The bending forces on the slide are considerably decreased if not entirely eliminated. The slide and its lower guide can be thinner with no sacrifice of overall force against the foot. This design saves material and manufacturing costs, especially when the stop is in the form of a crimp in the foot.

Various embodiments of the present invention will now be specified with reference to the drawing, which comprises a single FIGURE, a section through a jack in accordance with the invention.

The jack in the illustrated embodiment is an articulated single-arm jack with a foot pivoting on it. It is provided with an erect component in the form of a leg 1 with a foot 2 pivoting on it at the leg-supporting end and with a leg-supporting surface 3 resting against ground 4. A vehicle-lifting arm 5 is articulated to the upper section of leg 1. An unillustrated vehicle-supporting component matching the contact surface of the vehicle being lifted is mounted on the free end 6 of arm 5. This component can be articulated or otherwise attached to the arm and can for example fit the vehicle's sill. Leg 1 and arm 5 are connected by a threaded drive spindle 7 conventionally provided with a crank 9. An unillustrated traveling nut at the upper end 8 of leg 1 pivots arm 5 relative to leg 1 as crank 9 is turned, raising or lowering free end 6 and hence lifting the vehicle off or lowering it onto ground 4.

The angle of articulation between the foot 2 and leg 1 in the illustrated embodiment is controlled by a slide 10.

Foot 2, leg 1, and arm 5 are all fabricated from lengths of metal U section, each comprising a web 12 and two flanges 11. At the end of arm 5 remote from free end 6, flanges 11 are each provided with a cogged segment 13 extending approximately 180°. The cogs in the present example are rounded. Web 12 does not extend as far as segment 13. The web 14 in leg 1 is provided with a convexly outward recess 15 in the vicinity of segment 13 that allows the segment to rotate freely.

Slide 10 is in two parts, comprising a guide 16 and a pusher 17. The guide 16 in the illustrated example is a length of metal W section. The cogs in segment 13 engage matching gaps 18 in guide 16. The pusher 17 in the illustrated example is in the form of a rod with a bend 20 at its lower end 19. Bend 20 applies force against the web that constitutes the web of foot 2. The length and angle of bend 20 determines where lower end 19 will rest against the leg-supporting surface 3 of foot 2, allowing the foot's performance to be adopted to the characteristics of the specific vehicle being lifted.

A stop 21 is positioned on the upper surface of leg-supporting surface 3 and facing the lower end 19 of bend 20. The stop 21 in the illustrated example is in the form of an elevated transverse crimp in leg-supporting surface 3. The stop must of course conform with the overall design of the jack. Specifically, the exact position of the stop in relation to the point 22 of articulation of foot 2 to leg 1 will depend on the characteristics of the bend at lower end 19. When jacks are manufactured in small numbers accordingly, it can be economical to fabricate the foot with a smooth leg-supporting surface 3 and apply the stop later in the form of a rivet or welded-on pin. Although this approach will result in a slightly heavier jack, it will entail several advantages in small-scale manufacture.

List of Parts

1. leg

2. foot

3. leg-supporting surface

4. ground

5. vehicle-lifting arm

6. free end of arm 5

7. spindle

8. upper end of leg 1

9. crank

10. slide

11. flanges

12. web

13. cogged segment

14. web

15. outward recess

16. guide

17. pusher

18. gaps

19. lower end

20. bend

21. stop

22. point of articulation

1. Jack with an erect component in the form of a leg (1) that rests against the ground (4) and of a foot (2) articulated thereto and with a vehicle-lifting arm (6) that pivots around a fixed horizontal axis on the leg, that can be directly or indirectly raised or lowered away from and toward the ground by means of a spindle (7), and that is provided with a fixed or pivoting vehicle-supporting component at its free end and, at the other end, which engages the leg, with appropriate controls that displace a slide (10) along the leg such that the lower end (19) of the slide can come to rest against the leg-supporting surface (3) of the foot, characterized by a stop (21) positioned on top of the leg-supporting surface and facing the slide's lower end.

2. Jack as in claim 1, characterized in that the stop (21) is a rivet or welded-on pin.

3. Jack as in claim 1, characterized in that the stop (21) is a crimp in the leg-supporting surface (3).
